(19) United States
(12) Patent Application Publication
(10) Pub. No.: US 2011/0170809 A1
(43) Pub. Date: Jul. 14, 2011

(54) AUTOMATIC LUBRICATION STRUCTURE OF SLIDE MECHANISM

(76) Inventors: Tung-Hsin CHEN, Taichung City (TW); Tsung-Jen Chen, Taichung City (TW); Min-Yao Hsieh, Taichung City (TW)

(21) Appl. No.: 12/686,798

(22) Filed: Jan. 13, 2010

(51) Int. Cl. F16C 33/66

(52) U.S. Cl. 384/13

(57) ABSTRACT

An automatic lubrication structure of slide mechanism. The automatic lubrication structure includes a guide section, a slide section slidably disposed on the guide section, and a lubricating section fixedly disposed on the guide section. The lubricating section has an oil reservoir with an internal cavity for containing therein a lubricant or the like. The lubricating section further has a communication passage and multiple oil-filling holes formed on lateral sides of the guide section in contact with the slide section. The cavity communicates with the oil-filling holes via the communication passage. The slide section is movable to push a push member for making the lubricant or the like contained in the cavity spill out of the oil-filling holes so as to provide lubrication effect for contact faces between the guide section and the slide section.

### BACKGROUND OF THE INVENTION

The present invention relates generally to a linear motor, and more particularly to an automatic lubrication structure of slide mechanism.

FIG. 1 shows a conventional linear motor 1 having a mover 2 and a stator 3. The mover 2 is linearly reciprocally movable by means of the magnetic field effect between the mover 2 and the stator 3. The mover 2 is guided with linear guide rails 4 for controlling the linear track of the mover 2 and stabilizing the motion of the mover 2. The mover 2 is carried by sliders 5 slidably mounted on the slide rails 4, whereby the guide rails 4 can guide the mover 2 to reciprocally move.

To speak more specifically, ball bodies or rollers are held between the sliders 5 and the slide rails 4 to reduce frictional force so as to stabilize and smoothen the relative sliding motion of the sliders 5 along the slide rails 4. However, considerably great frictional force still exists between the ball bodies and the faces in contact with the ball bodies. Therefore, it is still necessary to lubricate the guide members.

FIG. 2 shows a conventional self-lubricating mechanism for lubricating the guide members. An oil reservoir 6 is connected with one side of the slider 5 for containing lubricating oil. The oil reservoir 6 has woolen felts 7 to provide capillary effect for feeding the lubricating oil reserved in the oil reservoir 6 between the ball bodies and the faces in contact therewith.

In normal use environment, such mechanism is able to achieve a certain lubricating effect. However, in a vacuum operation environment, the lubricating oil will have very high viscosity so that the capillary effect will be unapparent. Therefore, the guide members can be hardly lubricated with such self-lubricating mechanism in the vacuum operation environment. However, most of the production equipments for the current high-precision semiconductor products or plane displays require vacuum environment.

FIG. 3 shows a conventional pump-pressurized lubricating mechanism. By means of an external pressurizing pump 8, the lubricating oil is pumped into the slider 5 through an oil tube 9. The lubricating oil is then filled between the ball bodies and the faces in contact therewith. When using a linear motor in a vacuum operation environment, such mechanism is able to achieve the purpose of lubrication. However, in the vacuum environment, there is no medium so that the heat generated by the pressurizing pump 8 cannot be dissipated via air. Moreover, the pressurizing pump 8 is an additional component with respect to the linear motor, which will occupy much room and lead to increment of load. Accordingly, the pump-pressurized lubricating mechanism is not an optimal lubricating measure for the linear motor.

### SUMMARY OF THE INVENTION

It is therefore a primary object of the present invention to provide an automatic lubrication structure of slide mechanism, which can provide lubrication effect without using any additional power source.

It is a further object of the present invention to provide the above automatic lubrication structure of the slide mechanism, which can be adaptively used in a vacuumed environment to lubrication effect for an operating apparatus.

To achieve the above and other objects, the automatic lubrication structure of the slide mechanism of the present invention includes: a guide section having a linearly extending guide rail; a slide section slidably disposed on the guide rail, the slide section being drivable by an external to linearly reciprocally move along the guide rail between a forward position and a backward position; at least one rolling section rollably positioned between the slide section and the guide rail; and a lubricating section for providing a lubricant or the like between the guide rail and the slide section to lubricate contact faces between the rolling section, the guide rail and the slide section. The automatic lubrication structure is characterized in that the lubricating section has a hollow oil reservoir fixedly disposed on the guide section. The oil reservoir is formed with an internal cavity for containing the lubricant or the like therein. The lubricating section further has at least one oil-filling hole being formed on the guide section and at least one communication passage in communication with the oil-filling hole and the internal cavity of the oil reservoir. The lubricating section further has a push member. A first end of the push member extends into the internal cavity of the oil reservoir. A second end of the push member is positioned outside the oil reservoir and directed to the slide section.

The slide section is drivable by the external force to move into contact with the second end of the push member, whereby the first end of the push member is synchronously moved within the cavity to narrow a space thereof for containing the lubricant or the like. The lubricant or the like is extruded out of the cavity to go through the communication passage to the oil-filling hole and spill out to lubricate contact faces between the rolling section, the guide rail and the slide section.

The present invention can be best understood through the following description and accompanying drawings, wherein:

### BRIEF DESCRIPTION OF THE DRAWINGS

FIG. 1 is a perspective exploded view of a conventional linear motor;

FIG. 2 shows a conventional self-lubricating mechanism;

FIG. 3 shows a conventional pumped lubrication mechanism;

FIG. 4 is a perspective assembled view of a preferred embodiment of the present invention;

FIG. 5 is a perspective exploded view of the preferred embodiment of the present invention;

FIG. 6 is a sectional view of the lubricating section of the preferred embodiment of the present invention;

FIG. 7 is a sectional view taken along line a-a of FIG. 4, showing that the lubricating section is in a non-operated state;

FIG. 8 is a sectional view taken along line b-b of FIG. 7;

FIG. 9 is a sectional view according to FIG. 7, showing that the lubricating section is in an operated state; and

FIG. 10 is a perspective assembled view of another preferred embodiment of the present invention.

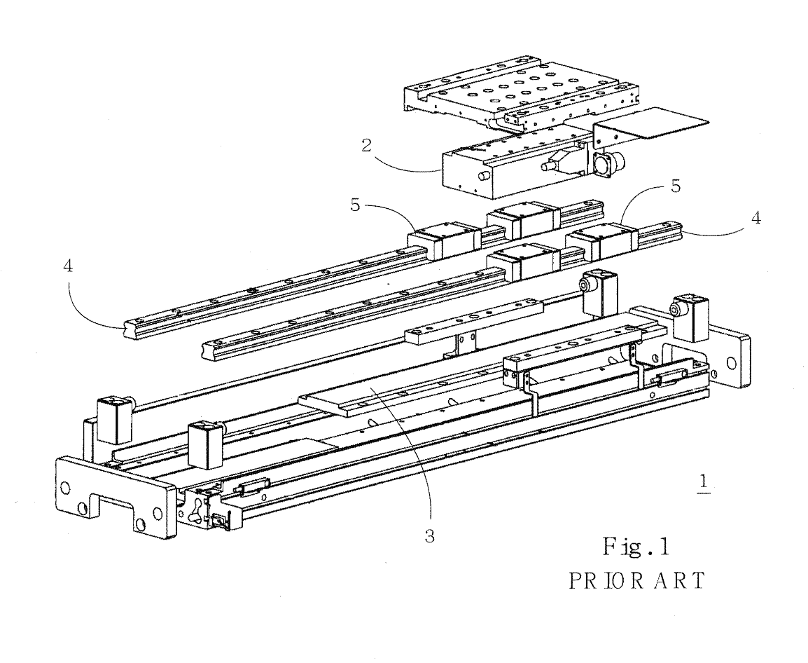

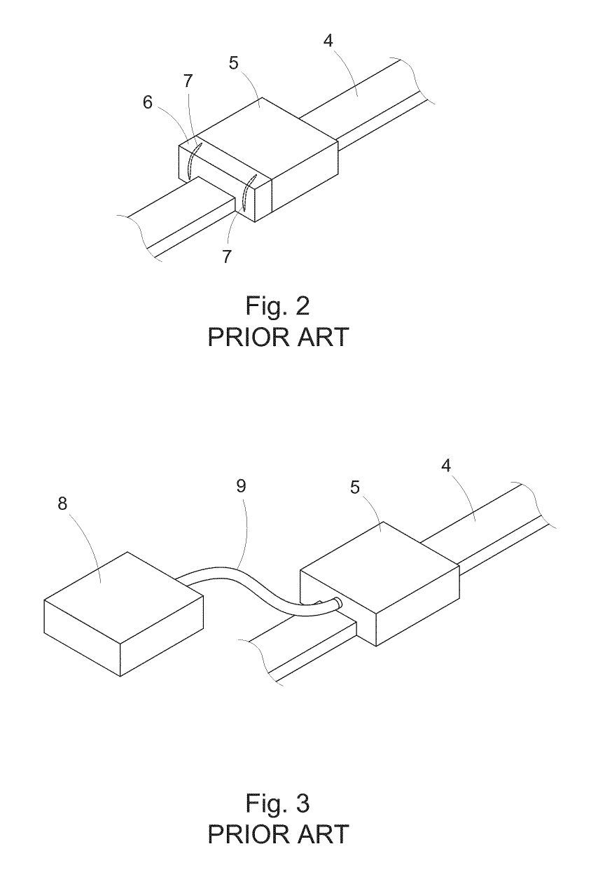

### DETAILED DESCRIPTION OF THE PREFERRED EMBODIMENTS

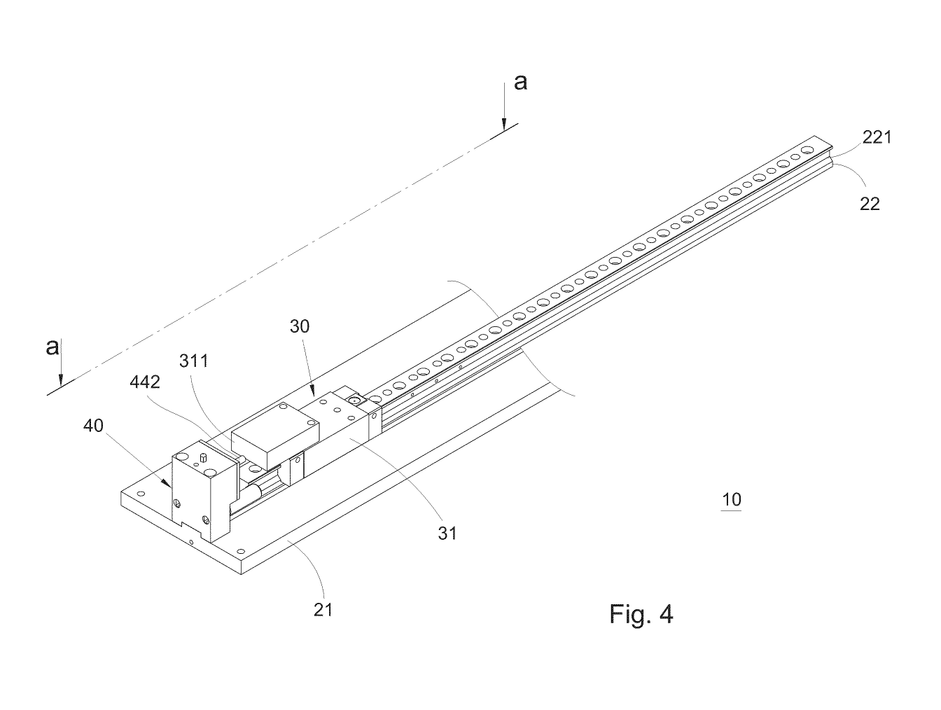

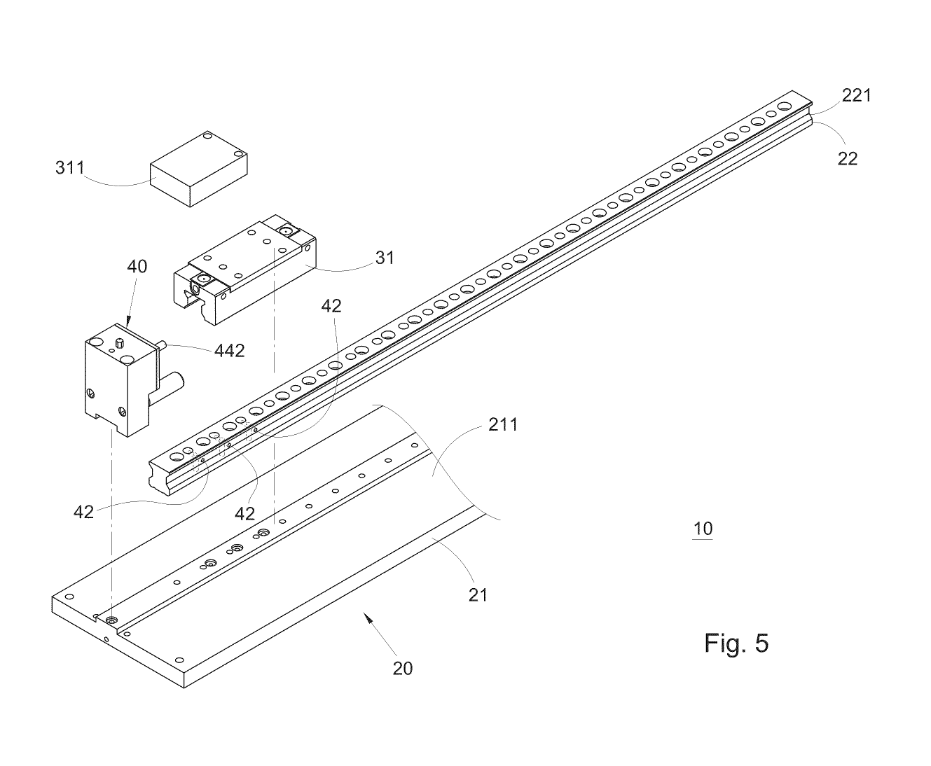

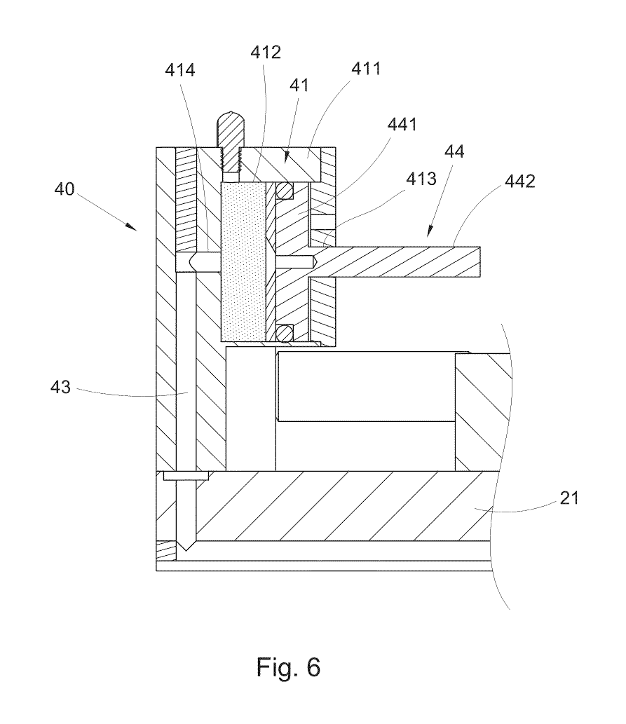

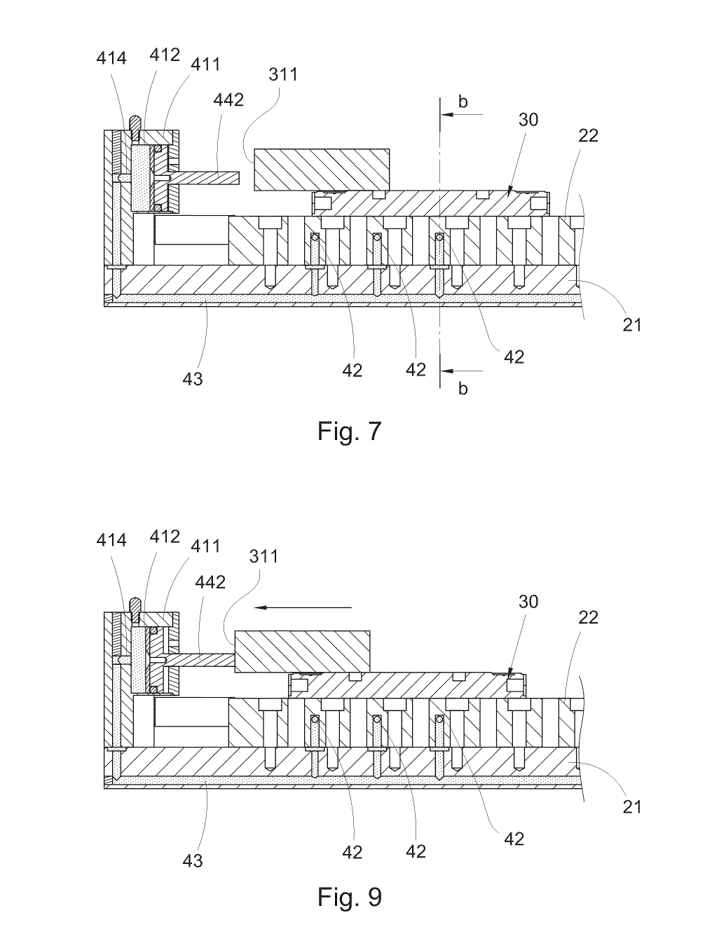

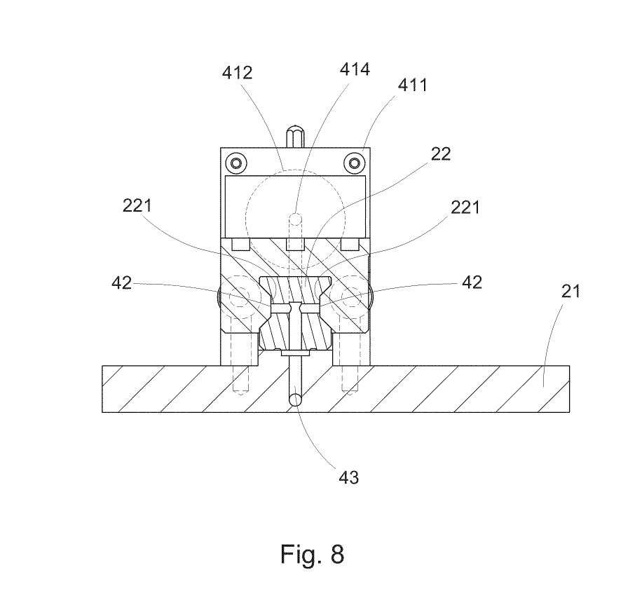

Please refer to FIGS. 4 to 9. According to a preferred embodiment, the automatic lubrication structure 10 of slide mechanism of the present invention serves as a component of a linear motor. The automatic lubrication structure 10 includes a guide section 20, a slide section 30, two rolling sections and a lubricating section 40.

The guide section 20 has a substantially rectangular horizontal substrate 21 with a certain thickness and an elongated strip-like guide rail 22. A bottom face of the guide rail 22 is attached to and fixedly disposed on an upper face 211 of the substrate 21. The guide rail 22 linearly extends in a direction parallel to a length of the rectangular substrate 21. Two opposite lateral sides of the guide rail 22 are respectively formed with lengthwise extending guide channels 221 with a certain depth.

The slide section 30 has a slide block 31 with a substantially U-shaped cross section. The guide rail 22 is inlaid in a bottom recess of the slide block 31, whereby the slide block 31 can be guided by the guide rail 22 to linearly reciprocally move along the guide rail 22 between a forward position and a backward position. This technique pertains to prior art and thus will not be further described hereinafter.

Each of the rolling sections (not shown) is composed of multiple balls or rollers. The rolling sections are rollably sandwiched and located respectively between inner opposite walls of the bottom recess of the U-shaped slide block 31 and the guide channels 221 of the guide rail 22. By means of the rolling sections, the slide section 30 can stably linearly move relative to the guide section 20 with a very low friction coefficient. This also pertains to prior art.

The lubricating section 40 has a hollow oil reservoir 41 with an internal cavity. The oil reservoir 41 is fixedly disposed on the upper face of the substrate 21 at a lengthwise end thereof in adjacency to one end of the guide rail 22. Multiple pairs of oil-filling holes 42 are respectively formed on the opposite lateral sides of the guide rail 22 in communication with the guide channels 221. A communication passage 43 extends from the internal cavity of the oil reservoir 41 to the oil-filling holes 42 to communicate the internal cavity therewith. The lubricating section 40 further has a push member 44. A first end of the push member 44 is slidably disposed in the internal cavity of the oil reservoir 41. A second end of the push member 44 is positioned outside the oil reservoir 41 and directed to an end face 311 of the slide block 31.

To speak more specifically, the oil reservoir 41 has a main body 411 formed with a cylindrical internal cavity 412 for containing therein a lubricant or the like. The cylindrical cavity 412 has an axis parallel to the length of the guide rail 23. A slide hole 413 and an outlet 414 are respectively formed on two opposite walls of the main body 411 at two axial ends of the cavity 412 in communication with the cavity 412. The axes of the slide hole 413 and the outlet 414 are parallel to the length of the guide rail 23.

The push member 44 has a disc-shaped piston body 441 coaxially received in the cavity 412 and axially movable within the cavity 412. The piston body 441 partitions the cavity 412 into two spaces. The push member 44 further has an elongated rod-like push body 442 coaxially fitted through the slide hole 413. A first end of the push body 442 is perpendicularly fixedly connected with one face of the piston body 441, while a second end of the push body 442 is positioned outside the main body 411 and directed to the end face 311 of the slide block 31.

The communication passage 43 extends from the outlet 414 through the main body 411 and the substrate 21 into the guide rail 22 to communicate with the oil-filling holes 42 on two lateral sides of the guide rail 22.

According to the above arrangement, the original power of the linear motor for controlling the motion of the slide section also serves as the power for operating the automatic lubrication structure 10 of the present invention. Therefore, it is unnecessary to use any additional power source for operating the lubrication structure as in the conventional device. When lubrication of the slide mechanism is needed, by means of the original power of the linear motor, the slide section 30 is driven to move to the backward position where the end face 311 of the slide block 31 abuts against the second end of the push body 442 to controllably push the push body 443 inward by a certain distance. At this time, the piston body 441 is synchronously moved within the cavity 412 to narrow the space for containing the lubricant or the like. Accordingly, the lubricant or the like is extruded out of the outlet 414 to go through the communication passage 43 to the oil-filling holes 42. The lubricant or the like then spills out of the oil-filling holes 42 to lubricate the contact faces between the rolling sections, the guide rail and the slide section.

In comparison with the conventional device, the automatic lubrication structure 10 of the slide mechanism of the present invention is operable by the original power of the linear motor without any additional power source. Therefore, the automatic lubrication structure 10 can be used at lower cost. Moreover, the automatic lubrication structure 10 can be used as a component of a linear motor operated in a vacuumed environment such as a vacuumed chamber to achieve reliable lubrication effect.

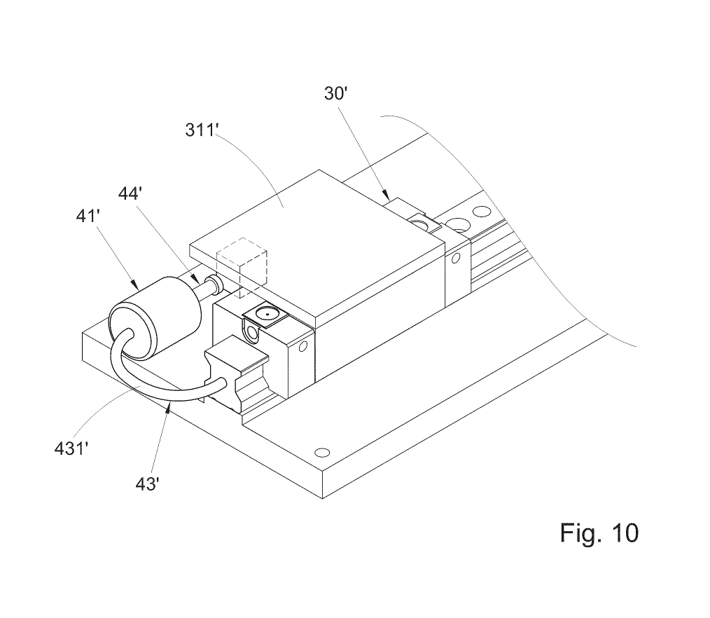

It should be noted that the above embodiment is only used to illustrate the present invention, not intended to limit the scope thereof. Many modifications of the above embodiment can be made without departing from the spirit of the present invention. The following are two examples of the modifications:
1. In the above embodiment of the present invention, the respective sections of the communication passage 43 are respectively hidden in the main body, the substrate and the guide rail. However, FIG. 10 shows a second embodiment in which a section of the communication passage 43′ is formed of an external pipeline 431′. In other word, the communication passage of the present invention serves as a flow way between the oil reservoir and the oil-filling holes and can be freely modified without limitation to the foregoing.
2. In the first embodiment of the present invention, the oil reservoir 41 is positioned in an extension line of the length of the guide rail 23. However, the position of the oil reservoir 41′ is changed in the second embodiment as shown in FIG. 10. In the second embodiment, the oil reservoir 41′ is positioned beside the extension line of the length of the guide rail 23′. An extension board 311′ laterally protrudes from one side of the slide section 30′ in a direction normal to the moving direction of the slide section 30′. The extension board 311′ is aligned with the second end of the push body of the push member 44′. Accordingly, the extension board 311′ can push the push member 44′ to extrude the lubricant or the like for achieving lubrication effect as the first embodiment.

What is claimed is:

1. An automatic lubrication structure of slide mechanism, comprising:
a guide section having a linearly extending guide rail;
a slide section slidably disposed on the guide rail, the slide section being drivable by an external to linearly reciprocally move along the guide rail between a forward position and a backward position;
at least one rolling section rollably positioned between the slide section and the guide rail; and
a lubricating section for providing a lubricant or the like between the guide rail and the slide section to lubricate contact faces between the rolling section, the guide rail and the slide section, said automatic lubrication structure being characterized in that the lubricating section has a hollow oil reservoir fixedly disposed on the guide section, the oil reservoir being formed with an internal cavity for containing the lubricant or the like therein, the lubricating section further having at least one oil-filling hole being formed on the guide section and at least one communication passage in communication with the oil-filling hole and the internal cavity of the oil reservoir, the lubricating section further having a push member, a first end of the push member extending into the internal cavity of the oil reservoir, a second end of the push member being positioned outside the oil reservoir and directed to the slide section, the slide section being drivable by the external force to move into contact with the second end of the push member, whereby the first end of the push member is synchronously moved within the cavity to narrow a space thereof for containing the lubricant or the like, whereby the lubricant or the like is extruded out of the cavity to go through the communication passage to the oil-filling hole and spill out to lubricate contact faces between the rolling section, the guide rail and the slide section.

2. The automatic lubrication structure of slide mechanism as claimed in claim 1, wherein the oil reservoir has a main body fixedly disposed on the guide section in adjacency to one side of the slide section in the backward position, the cavity being formed in the main body, a slide hole being formed through one side of the main body in communication with the cavity, an axis of the slide hole being parallel to an extension line of the guide rail, an outlet being formed through another side of the main body in communication with the cavity, the push member having a piston body slidably received in the cavity between the slide hole and the outlet, the push member further having an elongated push body coaxially slidably fitted through the slide hole, a first end of the push body being fixedly connected with the piston body, while a second end of the push body being positioned outside the main body and directed to an end face of the slide section, the end face of the slide section being normal to a moving direction of the slide section, whereby the slide section can slide into abutment with the second end of the push body.

3. The automatic lubrication structure of slide mechanism as claimed in claim 2, wherein the slide hole and the outlet are respectively formed through two opposite side walls of the main body.

4. The automatic lubrication structure of slide mechanism as claimed in claim 1, wherein the guide section further has a substrate with a certain thickness, the guide rail being fixedly disposed on an upper face of the substrate, the communication passage of the lubricating section extending from the oil reservoir through the substrate into the guide rail to communicate with the oil-filling hole thereof.
